(19) United States
(12) Patent Application Publication
(10) Pub. No.: US 2015/0073891 A1
(43) Pub. Date: Mar. 12, 2015

(54) Method and System For Determining User Advertising Ratings

(71) Applicant: Telefonaktiebolaget L M Ericsson (publ), Stockholm (SE)

(72) Inventor: Ankur DAUNERIA, New Delhi (IN)

(73) Assignee: Telefonaktiebolaget L M Ericsson (publ), Stockholm (SE)

(21) Appl. No.: 14/022,751

(22) Filed: Sep. 10, 2013

(51) Int. Cl. G06Q 30/02

(52) U.S. Cl. CPC G06Q 30/0246; G06Q 30/0205
USPC 705/14.44

(57) ABSTRACT

A method for determining a user advertising rating can include sending set of one or more of the advertiser's advertisements to the user's wireless communication device; i) obtaining location information indicating the geographic area in which the user's wireless communication device was located, or was assumed to be located, at the time the user's wireless communication device received the advertisement and ii) associating the obtained location information with the advertisement; receiving an indication that the user responded to at least one of the one or more advertisements; and associating at least a first of the one or more advertisements with information indicating that the user responded to the advertisement and determining, using a computer processor, the user advertising rating associated with the user and the geographic area.

### TECHNICAL FIELD

This disclosure relates to methods and systems for determining a user advertising rating. The rating can, for example, be associated with a geographic area and a user of a wireless communication device (WCD).

### BACKGROUND

Consumer behavior study can be based on consumer buying behavior, with the customer playing the three distinct roles of user, payer, and buyer. Research has shown that consumer behavior is difficult to predict, even for experts in the field. For example, consumer behavior may be influenced by internal conditions such as demographics, psychographics (lifestyle), personality, motivation, knowledge, attitudes, beliefs, and feelings. Psychological factors can, for example, include an individual's motivation, perception, attitude and belief, while personal factors can include income level, personality, age, occupation and lifestyle. Behavior can, for example, also be affected by external influences, such as culture, sub-culture, locality, royalty, ethnicity, family, social class, past experience reference groups, lifestyle, and market factors.

The ability to predict consumer behavior is especially important in the field of advertising. For at least this reason, there is a continuing need for improved methods and systems for measuring and tracking consumer behavior, especially with respect to determining the effectiveness of advertising.

### SUMMARY

In some embodiments, short messaging service (SMS) marketing and other similar types of marketing can be used to promote businesses to telecom subscribers (or “users”). This marketing can, for example, be in the form of advertisements sent to users to increase the relevance of marketing and/or advertising messages to a degree where a sufficient number of undecided and currently non-consuming receivers of the message are motivated by the advertisement to make a purchase of a product or service. This is illustrated in FIG. 12, which shows telecommunication network flow of SMS advertisements from advertisers (B1 . . . Bn) through a network 110 (see FIG. 1) to various users (U1 . . . Un). Effective responses from users towards the advertisements are captured by an Effective Response Analysis Engine (ERAE) 116.

The effectiveness of a marketing campaign can, for example, be defined by comparing the total costs for a marketing and/or advertising campaign with the profit generated by the number of sales that resulted as a direct response to the marketing campaign. Despite the investment of massive amounts of time, money, and research that has been focused on developing effective means to achieve attractive and profitable success in these advertiser-controlled marketing campaigns, the marketing and advertising industry continues to fail at providing methods and systems that return measurable and attractive responses to marketing and advertising investments.

As an illustration, response rates to direct mail marketing campaigns of one percent (1%) are considered average, and response rates reaching three percent (3%) are considered to be very good. Because of this low level of effectiveness, and because consumers generally have a negative view of poorly targeted advertising, this method of mass marketing/advertising is widely referred to as “junk mail” (when sent by e-mail for example) or “junk SMS” (when sent by SMS). Such poorly targeted advertising is also widely and negatively referred to as “spam.”

Information overload is an increasing problem as more and more data is available. Having more choices, on the surface, appears to be a positive development. However, it can hide an underlying problem: faced with too many choices, consumers can have trouble making optimal choices, and thus as a result can be indecisive, unhappy, and even refrain from making the choice (e.g., purchase) at all. Personalization of advertising can play a key role in reducing the information load and increasing the effectiveness of advertising. For example, the degree of customer involvement can often decide the impact of an advertisement. Therefore, feedback regarding the effectiveness of advertising can be used to better understand the most effective ways of personalizing advertisements.

Personalization can, for example, be accomplished via user feedback, activity and profiles configured by the user or another user. However, even after various personalizations it may still be possible that the user suffers from information overload from advertisers. The user may delete advertisements or decide not to take actions on them. In some cases, the user may decide to unsubscribe from one or more of the advertisements completely. Without adequate feedback on the effectiveness on an advertisement, an advertiser may continue sending advertisements to a user even if the user is not interested in the advertisement.

To target consumers based on their preferences, consumer personalization can come into the picture to use consumer choice and serve the consumer on those choices. Frequency of advertisements, advertisement content, user preferences, and user profiles may be taken into consideration to target users. In some situations, even after creating a user profile with suggested preferences, the user may still receive a large amount of advertisements, which can contribute to information overload. Information overload can, for example, be accumulated with time as consumer behavior may be hard to predict. For example, the user may not reply to every advertisement within a category. The user, may, for example, choose few advertisements in one category compared to other categories. In some cases, the user, may, for example, choose few advertisements compared to other users. In addition, due to information overload, it may be possible that the user loses interest in the whole category itself.

In view of the above, there is a need for more effective feedback to understand consumer behavior towards advertisements.

Accordingly, in one aspect, the present disclosure provides a method for determining user advertising ratings. In some embodiments, the method includes sending, for an advertiser, a set of one or more of the advertiser's advertisements to a user's wireless communication device. The method also includes, for each of said one or more advertisements, i) obtaining location information indicating the geographic area in which the user's wireless communication device was located, or was assumed to be located, at the time the user's wireless communication device received the advertisement and ii) associating the obtained location information with the advertisement. The method further includes receiving an indication that the user responded to at least one of the one or more advertisements, and, in response to receiving the indication, associating at least a first of the one or more advertisements with information indicating that the user responded to the advertisement. The method also includes determining, using a computer processor, a user advertising rating associated with the user and a geographic area based on i) a first value representing a number of advertisements that were transmitted to the user and associated with the geographic area and ii) a second value representing a number of advertisements that were transmitted to the user and associated with the geographic area and also associated with information indicating that the user responded to the advertisement.

In some embodiments, receiving an indication that the user responded to at least one of the one or more advertisements comprises receiving purchase information indicating that the user purchased a product from the advertiser. The purchase information may include one or more of: the name of the advertiser; information indicating that the user used the wireless communication device to purchase the product; and information indicating that the user used the wireless communication device to pay for the product via a contactless payment system. The contactless payment system may be a near field communication (NFC) payment system, a contactless credit/debit card system, etc.

In some embodiments, receiving an indication that the user responded to at least one of the one or more advertisements comprises receiving information indicating that the user has taken a certain action with respect to the advertisement.

In some embodiments, the advertisements are in the form of a short message service (SMS) message.

In another aspect, the disclosure provides an advertising system for determining user advertising ratings. In some embodiments, the advertising system comprises a data processing system for executing an effective response analysis engine (ERAE). The advertising system is configured to: send, for an advertiser, a set of one or more of the advertiser's advertisements to a user's wireless communication device; for each of said one or more advertisements, associate location information with the advertisement, the location information indicating the geographic area in which the user's wireless communication device was located, or was assumed to be located, at the time the user's communication device received the advertisement; in response to receiving information indicating that the user responded to at least one of the one or more advertisements, associate at least one of the one or more advertisements with information indicating that the user responded to the advertisement; and determine a user advertising rating associated with the user and a geographic area based on i) a first value representing the number of advertisements that were transmitted to the user and associated with location information indicating the geographic area and ii) a second value representing the number of advertisements that were transmitted to the user and associated with the geographic area and also associated with information indicating that the user responded to the advertisement.

### BRIEF DESCRIPTION OF THE DRAWINGS

FIG. 1 illustrates system according to some embodiments.

FIG. 2 is a flow chart illustrating a process according to some embodiments.

FIG. 3 illustrates a data structure according to some embodiments.

FIG. 4 illustrates a user at an exemplary point of sale location.

FIGS. 5-7 illustrate data structures according to some embodiments.

FIG. 8 is a map that depicts advertising ratings for users in a single geographic area.

FIG. 9 is a map that depicts advertising ratings for a first set of users in a geographic area and a second set of users in a second geographic area.

FIG. 10 is a map that depicts advertising ratings for a first set of users in a geographic area, a second geographic area, and a third geographic area.

FIG. 11 is a block diagram illustrating an advertising system according to some embodiments.

FIG. 12 illustrates a number of advertisers sending advertisements to a number of user of a network.

### DETAILED DESCRIPTION

The following description is intended to convey a thorough understanding of the embodiments described by providing a number of specific embodiments and details relating to methods and systems for determining a user advertising rating. It should be appreciated, however, that the present invention is not limited to these specific embodiments and details, which are exemplary only. It is further understood that one possessing ordinary skill in the art would appreciate the use of the invention for its intended purposes and benefits in any number of alternative embodiments, depending upon specific design and other needs.

For the sake of brevity, various aspects and embodiments of this disclosure are illustrated in an environment in which short messaging service (SMS) messages are used to send advertisements to users of a wireless telecommunication network, with the user's response to the advertisement determined through use of an NFC payment system. However, the aspects and embodiments are equally applicable to other forms of marketing, such as for example, multimedia messaging service (MMS), e-mail messages, and/or push notifications may be used. Likewise, the term “advertisements” can be broadly construed to include information relating to products, services, branding, or other information relating to a business, individual, organization, and/or other entity. For example, the advertisement can be in the form of communications relating to the price of an advertiser's product or services. The advertisement may additionally or alternatively be in the form of a coupon or voucher for user by the user. The advertisement may provide additional or alternative information or promotions. Moreover, one or more alternative types of networks may be used, such as, for example, a wireless local area network, satellite network, and/or another suitable type of network.

In addition, an alternative response system, such as an alternative contactless payment system or other suitable response systems can be used.

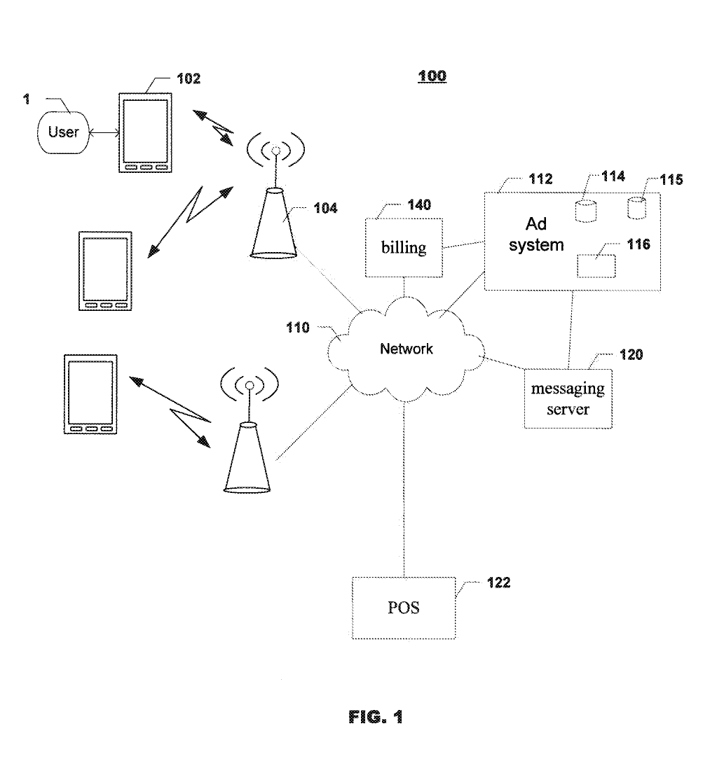

FIG. 1 illustrates an example system 100 according to some embodiments. System 100 includes a wireless communications network that includes a network 110 connected to various wireless transceivers 104 (e.g., base stations, access points, etc.). That is, network 110 may include, among other networks, a telecom operator's core network. For example, in addition to including a core network, network 110 may include or more of: the Internet, the public switched telephone network (PSTN), and a private network, which may be interconnected. The wireless transceivers 104 send data to and receive data from wireless communication devices 102 (e.g., smartphones, tablets, computers, etc.).

System 100 also includes an advertising system 112 that includes a database of advertisements 114 that have been provided by or on behalf of advertisers. Advertisements in database 114 may simply be text messages. Such advertisements may be transmitted to any of the WCDs 102 using a messaging service (e.g., an SMS, an MMS, or other messaging service). Accordingly, system 100 includes a messaging server 120 for sending messages (e.g., SMS messages, MMS messages, or other messages), including advertisements, to WCDs 102.

The advertisers who provide advertisements to advertising system 100 would like to obtain information regarding the effectiveness of its advertisements. For example, it would be beneficial to an advertiser for the advertiser to learn that its advertisements are most effective when sent to WCDs 102 that are located in densely populated urban areas and least effective when sent to WCDs 102 that are located in rural areas. Hence, advertising system 112 includes ERAE 116. Advertising system 112 and ERAE 116 may be implemented in many different ways. For example, ERAE 116 may be a distributed system comprising geographically dispersed server computers. At the other extreme, ERAE 116 may be implemented on a single computer using a monolithic software architecture.

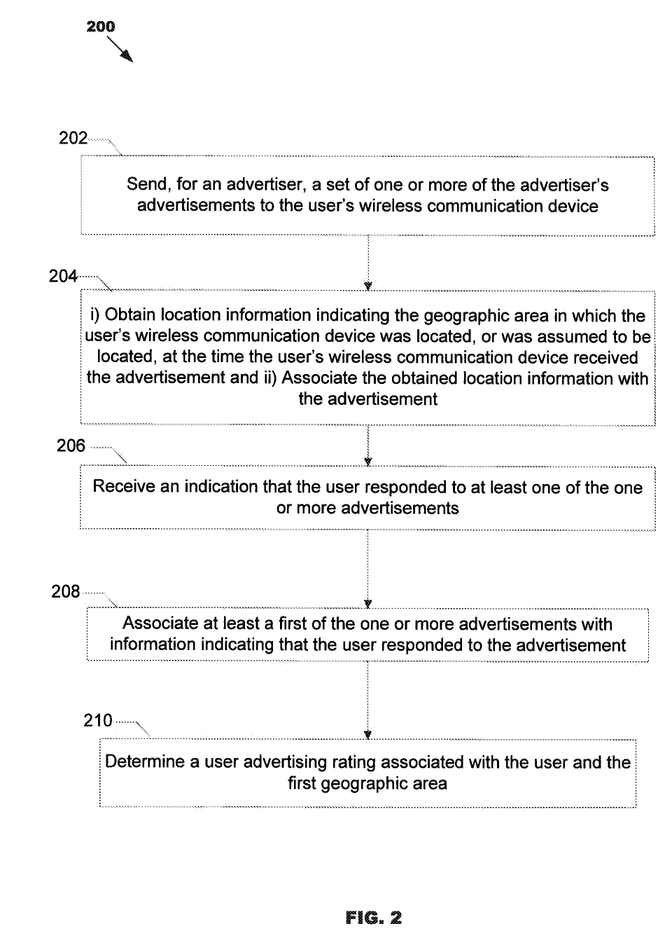

FIG. 2 illustrates a process 200 performed by advertising system 112. Process 200 may begin in step 202, where advertising system 112 sends, for an advertiser, a set of one or more of the advertiser's advertisements to a user's wireless communication device (e.g., user l′s WCD 102). The advertisements may be sent to WCD 102 using SMS or other delivery method (e.g., MMS, e-mail, etc.).

In step 204, the advertising system 112, for each of the one or more advertisements, i) obtains location information indicating the geographic area in which the WCD 102 was located (or was assumed to be located) at the time WCD 102 received the advertisement and ii) associates the obtained location information with the advertisement.

In some embodiments, in sub-step i) of step 204, the advertising system obtains the location information from a core network node of a core network of network 110, such as a mobility management entity (MME) or other entity that keeps track of WCD 102′s position. The location information may be in the form of a cell identifier, a base station identifier, a tracking area identifier, or coordinates (e.g., latitude and longitude).

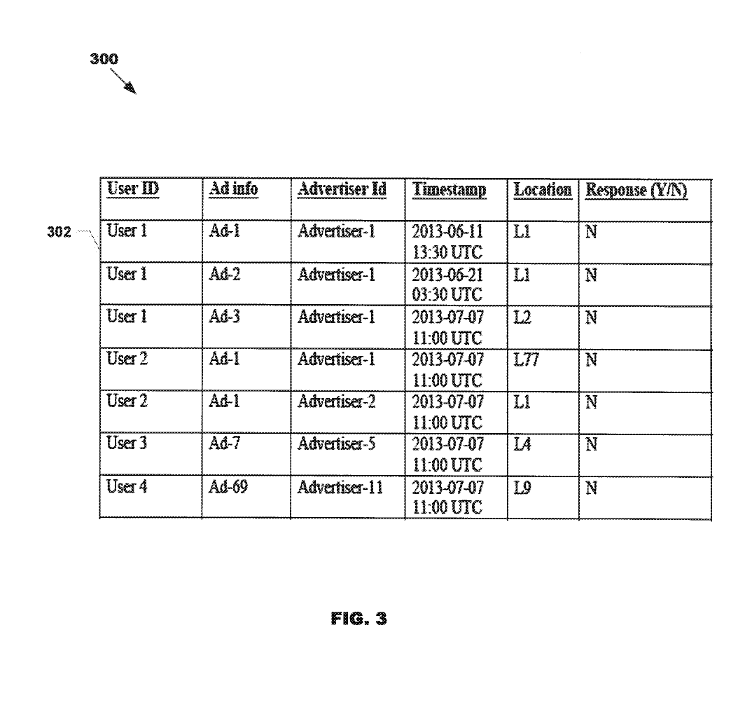

In some embodiments, in sub-step ii) of step 204 uses a data structure to associate obtained location information with the advertisement. An example data structure that may be used to associate the location information with the advertisement is illustrated in FIG. 3. As shown in FIG. 3, the data structure may be a record that is added to a table 300 of a database 115. Database 115 is a relational database in some embodiments. As shown in FIG. 3, table 300 consists of a set of records 302 and each record records information regarding a particular advertisement sent to a user. In the example shown, each record includes: a user identifier (e.g., the user's phone number or other user identifier); information pertaining to the advertisement (e.g., a coupon code included in the advertisement); an identifier identifying the advertiser; a timestamp identifying the date and time the advertisement was received; and location information identifying the location of the user's WCD at the time the advertisement was received. By creating such a record for each advertisement that it sends, advertising system 112 can keep track of information regarding the advertisement and, as described herein, record whether or not the user to whom the advertisement was sent responded to the advertisement (e.g., purchased the advertised product or purchased any product sold by the advertiser). Each record of table 300 can include one or more additional or alternative fields, such as: a field identifying the form in which the advertisement was transmitted (e.g., SMS, e-mail, MMS), a field identifying the location of the response, a field identifying the time of the response, and a field identifying the form of the response (e.g., purchase through a contactless payment system).

In step 206, the advertising system 112 receives an indication that user 1 responded to at least one of the advertiser's advertisements that was sent to the user's WCD 102 in step 202. For example, in some embodiments, as a result of user 1 using his WCD 102 to purchase a product from the advertiser, advertising system 112 receives message that includes purchase information, which information may include: an identifier that identifies the user (e.g., an identifier tied to WCD 102); a coupon code (if the user used a coupon to purchase the item); and an identifier that identifies the advertiser (e.g., the name of the business that sold the item to the user), information identifying the item(s) purchased, information identifying the location of the purchase, etc. Such a message may be treated as an indication that the user responded to an advertisement by the advertiser. The message is also an indication that the user responded to the advertisement by purchasing an item (product or service) from the advertiser using WCD 102.

For instance, the advertiser may have a retail store that includes a point of sale (PUS) device 122 that (1) is able to communicate with the user's WCD 102 so that the user can use the WCD 102 to pay for items sold by the retail store and (2) is able to provide information to advertising system 112 regarding purchases the user makes in the store using the WCD 102. That is, in some embodiments, POS 122, in response to the user using WCD 102 to pay for an item, transmits via network 110 (e.g., a dedicated communication link of network 110) to a billing system 140 a message including purchase information described above, and the billing system may provide this purchase information to advertising system 112.

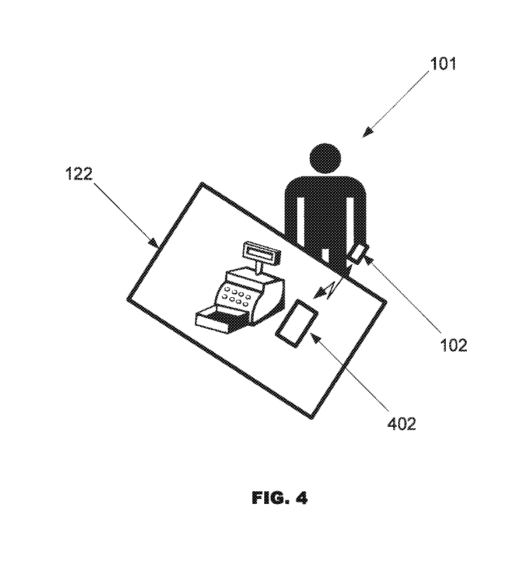

For example, in some embodiments, POS device 122 includes a payment unit 402 (see FIG. 4) that can communicate wirelessly with WCD 102. Payment unit 402 may, for example, communicate wirelessly with WCD 102 using any available technology, including: near field communication (NFC) technology (e.g., radio frequency id (RFID)), Bluetooth, Wi-Fi, infrared, etc. It is appreciated that the use of such a payment unit 402 can enable advertising system 112 to have knowledge about the payments user 101 makes using WCD 102. As described herein, the advertising system 112 can use this knowledge to develop relationship between advertisements of various advertisers sent to users and effective sales that a user has done by buying the products/services when the user pays through an NFC enabled mobile phone. In some embodiments, the contactless payment system may be conducted via a suitable.

In some embodiments, advertising system 112 may receive the indication that user 1 responded to at least one of the advertiser's advertisements that was sent to the user's WCD 102 in step 202 without the user having to make a purchase. For example, response information can be provided whenever user 1 takes a certain action with respect to the advertisement (e.g., whenever user 1 clicks on a link in the advertisement, saves the advertisement, prints the advertisement, provides feedback, etc.).

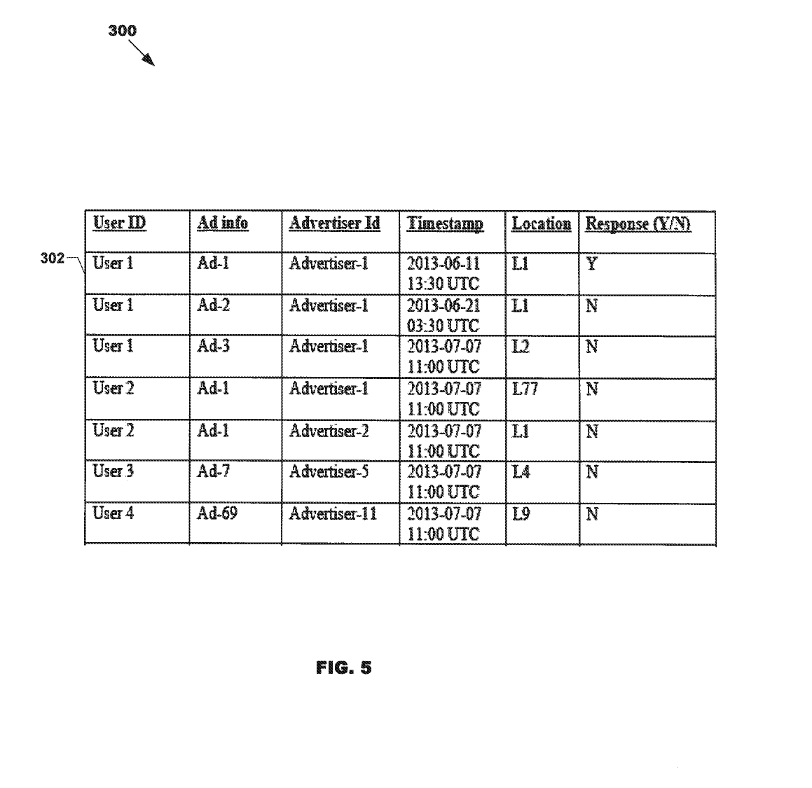

In step 208, the advertising system 112, in response to receiving the indication, associates at least one of the one or more advertisements with information indicating that user 1 responded to the advertisement. For example, in some embodiments, when advertising system 112 receives the purchase information as described above, the advertising system uses information included in the purchase item to update the record of table 300 that matches to the purchase information. Advertising system 112 updates the record by modifying the “response” field of the record such that it includes a “Y” instead of a “N,” to signify that the user responded to the advertisement associated with the record. This is illustrated in FIG. 5, which shows that record 302 has been updated (more specifically, the “response” field of record 302 has been updated to indicate that the user has responded to the advertisement).

In some embodiments, a record of table 300 matches the purchase information when (1) the user id included in the record matches the user id included in the purchase information and (2) the advertisement information included in the record (e.g., a coupon code) matches the advertisement information (e.g., coupon code) included in the purchase information. In other embodiments (e.g., embodiments in which advertisements do not include coupon codes), a record of table 300 matches the purchase information when (1) the user id included in the record matches the user id included in the purchase information and (2) the advertiser identifier included in the record matches the advertiser identifier included in the purchase information. It is possible that more than one record of table 300 may match the purchase information. In that case, advertising system 112 may update each of the matching records or may update less than all of the matching records (e.g., it may select only a single one of the matching records to update).

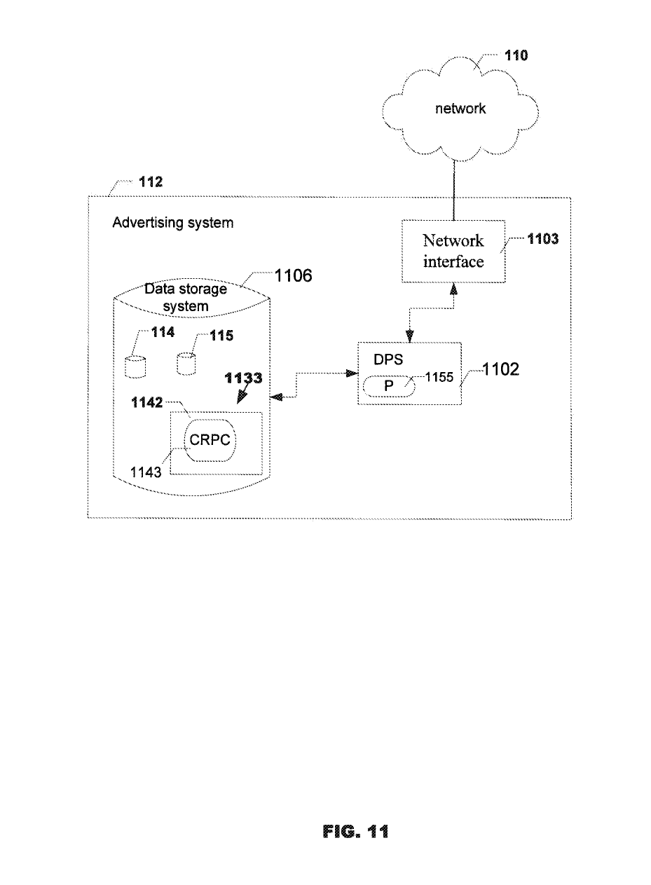

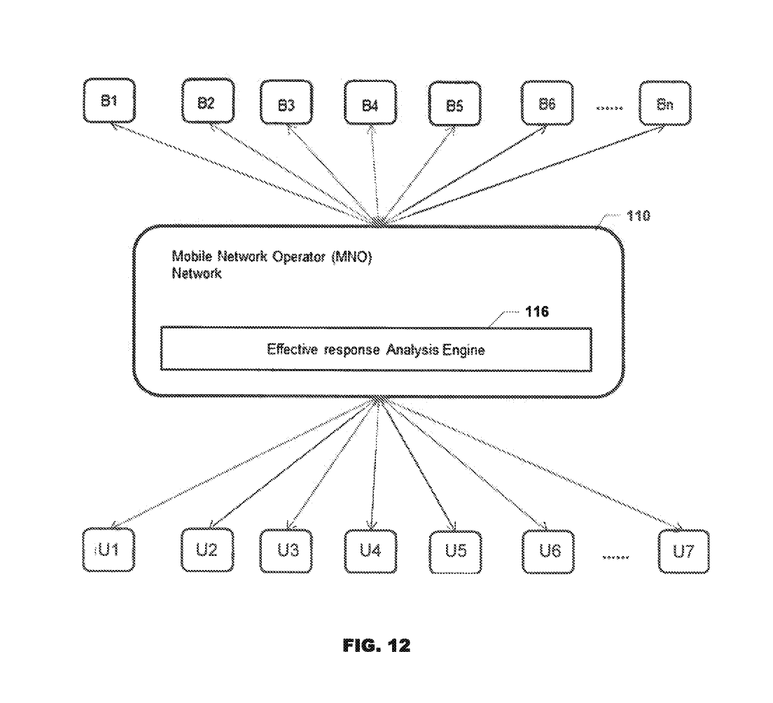

In step 210, advertising system 112 uses a data processing system 1102 (see FIG. 11) to execute the ERAE 116 to determine a user advertising rating for user 1 and for a particular geographic area. In some embodiments, the user advertising rating for user 1 is based on (1) a first value (v1) representing the number of advertisements that were transmitted to user 1 and associated with the particular geographic area (e.g., associated with location information identifying a location within the particular geographic area) and (2) a second value (v2) representing the number of advertisements that were transmitted to the user and associated with the particular geographic area and also associated with information indicating that the user responded to the advertisement.

As an example, let's assume that advertising system is configured to produce an advertising rating for user 1 and for a geographic area that includes location L1, but not Location L2. Using these parameters and referring to table 300 shown in FIG. 5, it is apparent that (i) the number of advertisements that were transmitted to user 1 and associated with the particular geographic area is two (i.e., v1=2; Ad-1 and Ad-2) and (ii) the number of advertisements that were transmitted to the user and associated with the particular geographic area and also associated with information indicating that the user responded to the advertisement is one (i.e., v2=1; Ad-1). Using these two values (v1 and v2), ERAE 116 can compute a user advertising rating for user 1. ERAE 116 may use one of the following formulas to compute the user advertising rating for user 1 and for the particular geographic area:

R1=(v2/v1)×100 or R2=(1−(v2/v1))×100, where R1 represent the percentage of ads that the user responded to and R2 represents the percentage of ads the user ignored. R2 is also knows as a “junk” rating (JR).

In some embodiments, instead of or in addition to determining a user advertising ratings for a particular user and particular geographic areas, ERAE 116 determines a user advertising rating for a particular user and particular periods of the day (e.g., morning, afternoon, evening, and night). In this way, ERAE 116 can see patterns as to when advertisements are most effective and generating a response from the user. Additionally, a user's user advertising rating can be calculated not only based on geographic areas and times of day, but also based on the form of the advertisement. Thus, a particular user can have various user advertising ratings specific to SMS advertisements as well as various user advertising ratings specific to e-mail advertisements.

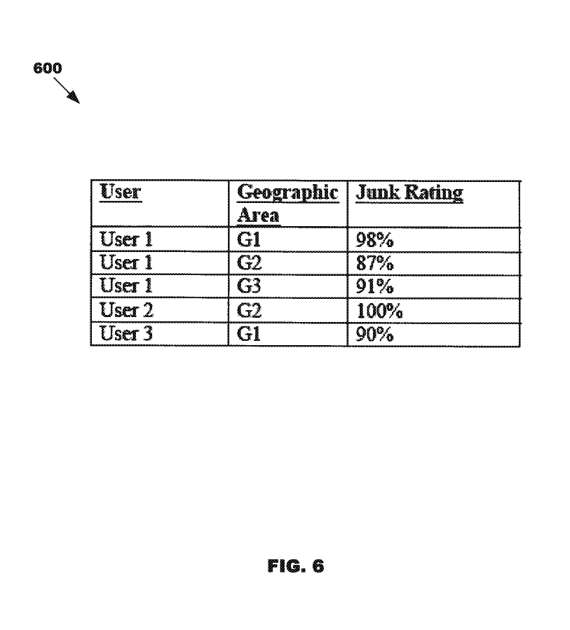

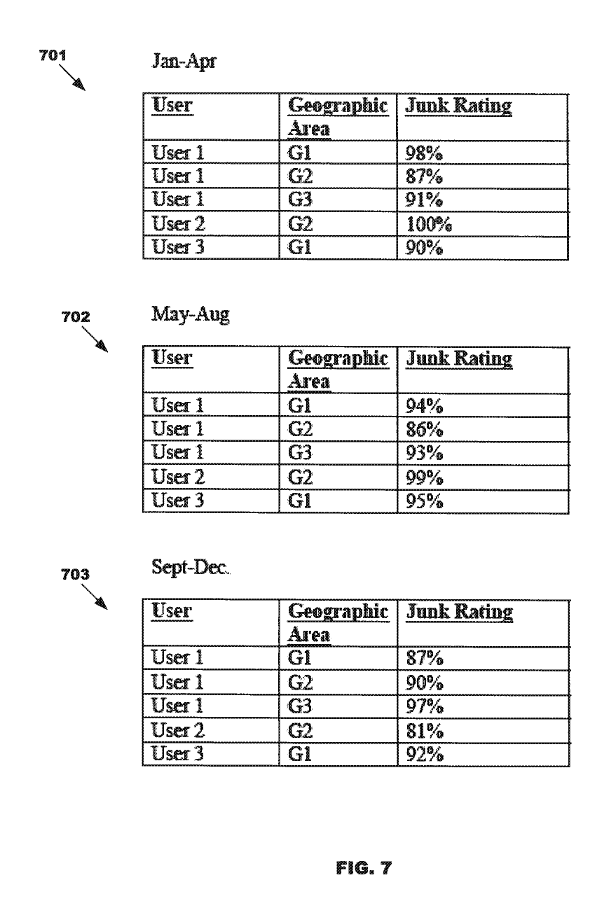

Advertising system 112 can perform process 200 for any number of users and, thereby, generate and store advertising ratings for various users and various geographic regions. FIG. 6 illustrates an example of such a user advertising ratings data structure 600, which may be a table of database 115. As shown in FIG. 6, advertising system 112 can generate and store a table of user advertising ratings for various user and various geographic locations. As an example, as shown in FIG. 6, the user advertising rating for User 1 and geographic region G1 is 98% (in this example the advertising rating is a Junk Rating). In some embodiments, advertising system 112 can generate such user advertising ratings for different time periods. Accordingly, database 115 may store multiple tables like table 600, where each table is for a different time period. This is shown in FIG. 7, which shows a user advertising rating table 701 for a first time period (e.g., Jan. to Apr.), a second user advertising rating table 702 for a second time period (e.g., May to Aug.), and a third user advertising rating table 703 for a third time period (e.g., Sept. to Dec). This feature enables a user of ERAE 116 to spot trends over time.

In some embodiments, aggregating and understanding the data of effective responses by a user to advertisements can be performed using an ERAE 116. The ERAE can measure effective responses of telecom user at any time and location. It can, for example, help develop relationship between advertisements and responses the system receives from telecom users. As discussed above, responses can, for example, be communication responses or payments responses done by subscriber (or consumer) against advertisements.

Advertisers can benefit from information regarding one or more user's advertising rating. For example, this information can allow the advertiser to design and target potential customers in a location at a time in a telecom network. Such information can be used to help to understand the information overload problems at subscriber end even after personalization is applied using user inputs. Such information can be used to help reduce cost and improves better chances of targeting the audience for SMS ads. Advertising rating for users can serve as feedback for business who can use this rating to plan their promotions, services, products and target audience whose numbers is always changing. As another example, a mobile network operator may profile an advertiser that regularly get no or minimum responses from users.

For example, feedback from a user can be used to form personalization schemes such that user feedback through profiles, preferences, activity traces becomes the basis to provide certain advertisements. Frequency of advertisements and advertisement content can further be considered while targeting consumers. As another example, the use of advertising rating maps specific to advertisements, users, locations, times, and the like can be compared with or without historical data to generate predictions and trends.

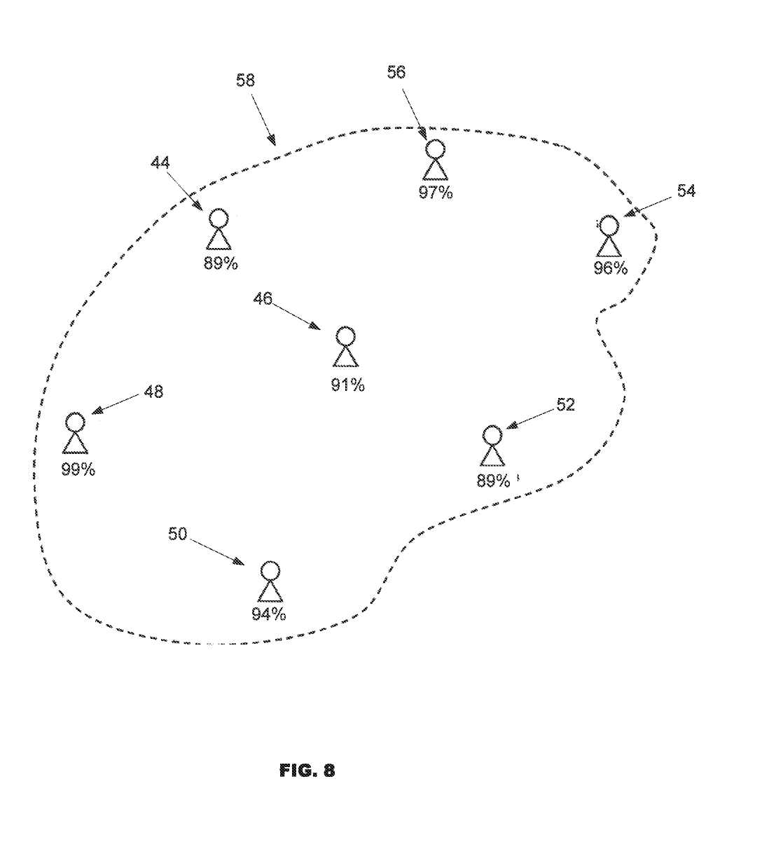

In some embodiments, ERAE 116 may generate user advertising rating maps for different geographic areas and or time periods using the information maintained in database 115 (e.g., table 300). Examples of such advertising ratings maps are illustrated in FIGS. 8-10.

As shown for example in FIGS. 8-10, advertising rating maps can be generated using aggregated advertising ratings of groups of users such that the users are depicted next to their user-specific advertising ratings. Percentage advertising ratings per user can, for example, vary from 0-100% and may be displayed directly on the advertising rating map. In these figures, each depicted user's Junk Rating is shown—which means that the higher the value of a user's advertising rating, the more likely that the user is getting advertisement overload in which he/she is not interested and would possibly not take any effective actions (such as, e.g., making a purchase of a product or service, or inquiring about something). Users with higher Junk ratings may delete or ignore more of their advertisements without taking effective actions. A lower Junk rating can correspond to a user appreciating more of their advertisements, and may indicate that the user is more likely to respond to advertisements, thereby resulting in increased products sales of businesses.

FIG. 8 is a location specific “Junk” map that illustrates, for users 44, 46, 48, 50, 52, 54, and 56, the users' Junk Rating for a given geographic area 58. Using a location specific Junk map, comparisons with the historical data can be made so as to measure, understand and predict the trend of a user's response to advertisements that they are receiving. Various locations can be compared so as to understand consumer behavior and information overload problems at various locations(s) towards advertisements of various advertisers. This could be a scenario when comparing Junk maps of, for example, rural and urban areas to understand consumer behavior and information load situation.

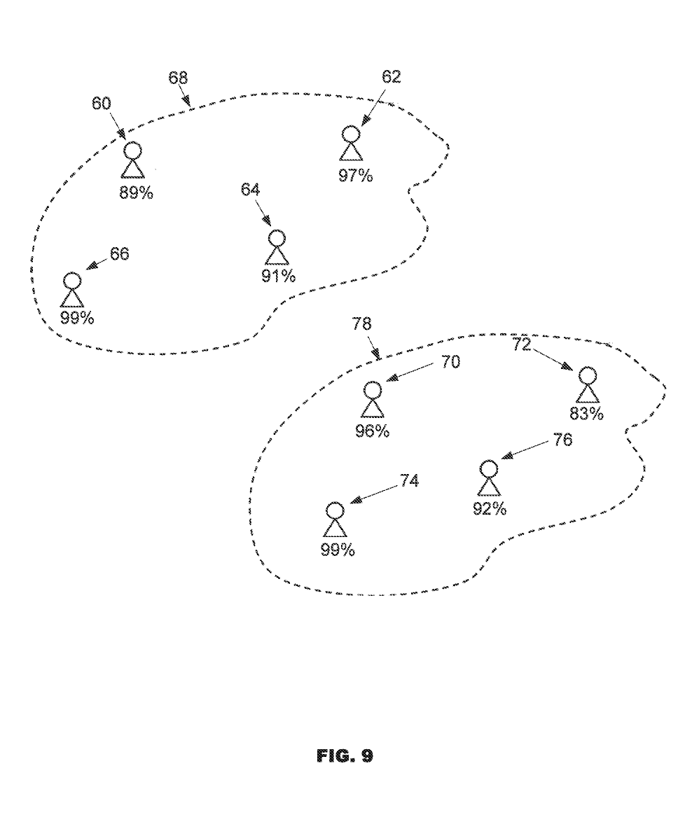

For example, FIG. 9 is a map that illustrates advertisement response information for a first group of users (60, 62, 64, 66) in a first geographic area 68 and a second group of users (70, 72, 74, 76) in a second geographic area 78. The information depicted in the map of FIG. 9 can, for example, be used to provide insight into trends relating to the effectiveness of certain advertisements for different users in different geographic areas.

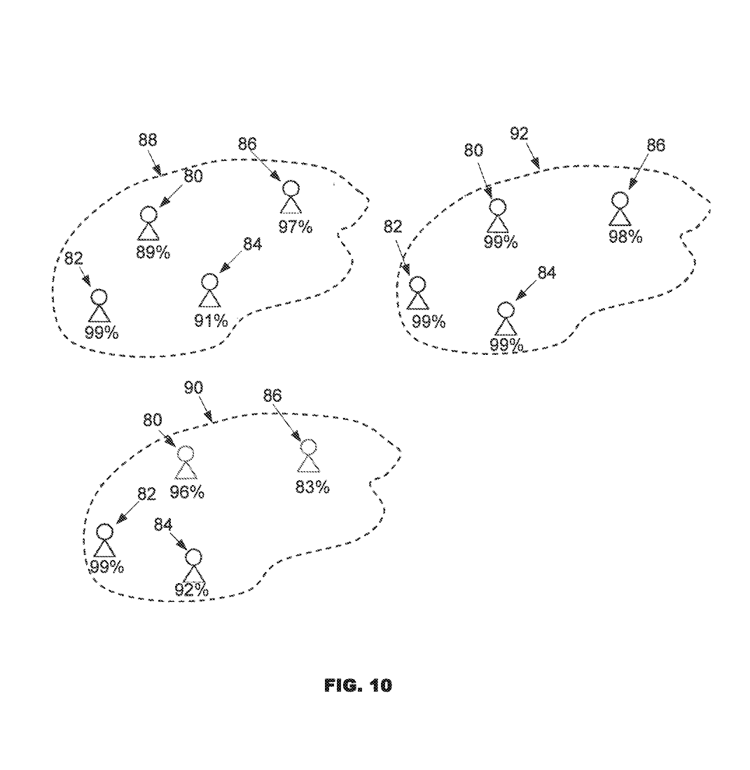

FIG. 10 is a map that illustrates advertisement response information for four users (80, 82, 84, 86) at a first geographic area (88), at a second geographic area (90), and at a third geographic area (92). The information depicted in the map of FIG. 10 can, for example, be used to provide insight into trends relating to the effectiveness of advertisements based on specific users, locations. For example, as shown in FIG. 10, user 80 is tracked during some monitored time period (e.g., a month). The advertising rating of user 80 at first geographic area 88 is 89%, at second geographic area 90 is 96% and at third geographic area 92 is 99%. These results reveal a trend that subscriber is most active in responding to advertisements at area 88. At area 92, almost all of advertisements ended up as junk. The user's response was at minimum when the user was at area 92. The map also shows increasing junk pileup when the user moves from area 88 to 90 to 92. It also shows that more than 88% of total advertisements end up as junk at any time and location for this user.

FIG. 11 illustrates a block diagram of advertising system 112, according to some embodiments. As shown in FIG. 11, advertising system 112 includes: a data processing system (DPS) 1102, which may include one or more processors (P) 1155 (e.g., microprocessors) and/or one or more circuits, such as an application specific integrated circuit (ASIC), Field-programmable gate arrays (FPGAs), etc.; a network interface 1103 for receiving messages from, and transmitting messages to, various nodes of network 110; a data storage system 1106, which may include one or more computer-readable data storage mediums, such as non-transitory memory unit (e.g., hard drive, flash memory, optical disk, etc.) and/or volatile storage apparatuses (e.g., dynamic random access memory (DRAM)), for storing, among other things, databases 114 and 115. In embodiments where data processing system 1102 includes a processor 1155 (e.g., a microprocessor), a computer program product 1133 may be provided, which computer program product includes: computer readable program code 1143 (e.g., instructions), which implements a computer program, stored on a non-transitory computer readable medium 1142 of data storage system 1106, such as, but not limited, to magnetic media (e.g., a hard disk), optical media (e.g., a DVD), memory devices (e.g., random access memory), etc. In some embodiments, computer readable program code 1143 is configured such that, when executed by data processing system 1102, code 1143 causes the data processing system 1102 to perform steps described herein (e.g., steps shown in FIG. 2).

While various aspects and embodiments of the present disclosure have been described above, it should be understood that they have been presented by way of example only, and not limitation. Thus, the breadth and scope of the present disclosure should not be limited by any of the above-described exemplary embodiments. Moreover, any combination of the elements described in this disclosure in all possible variations thereof is encompassed by the disclosure unless otherwise indicated herein or otherwise clearly contradicted by context.

Additionally, while the processes described herein and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for determining a user advertising ratings, the method comprising:
sending, for an advertiser, a set of one or more of the advertiser's advertisements to a user's wireless communication device;
for each of said one or more advertisements, i) obtaining location information indicating the geographic area in which the user's wireless communication device was located, or was assumed to be located, at the time the user's wireless communication device received the advertisement and ii) associating the obtained location information with the advertisement;
receiving an indication that the user responded to at least one of the one or more advertisements, and, in response to receiving the indication, associating at least a first of the one or more advertisements with information indicating that the user responded to the advertisement; and
determining, using a computer processor, a user advertising rating associated with the user and a geographic area based on i) a first value representing a number of advertisements that were transmitted to the user and associated with the geographic area and ii) a second value representing a number of advertisements that were transmitted to the user and associated with the geographic area and also associated with information indicating that the user responded to the advertisement.

2. The method of claim 1, wherein receiving an indication that the user responded to at least one of the one or more advertisements comprises one or more of: receiving purchase information indicating that the user purchased a product from the advertiser and receiving information indicating that the user has taken a certain action with respect to the advertisement.

3. The method of claim 2, wherein the purchase information not only indicates that the user purchased a product from the advertiser, but also indicates that the user used the wireless communication device to purchase the product.

4. The method of claim 2, wherein the purchase information not only indicates that the user purchased a product from the advertiser, but also indicates that the user used the wireless communication device to pay for the product via a contactless payment system.

5. The method of claim 4, wherein the contactless payment system is a near field communication (NFC) payment system.

6. The method of claim 2, wherein the purchase information includes the name of the advertiser.

7. The method of claim 2, wherein the purchase information includes the location of the purchase.

8. The method of claim 2, wherein the purchase information includes information identifying an item purchased from the advertiser.

9. The method of claim 1, wherein the advertisement is in the form of a short message service (SMS) message.

10. The method of claim 1, wherein the advertisement is in the form of a multimedia messaging service (MMS) message.

11. The method of claim 1, wherein the step of determining the user advertising rating is based on one or more of the user's responses to a single advertisement.

12. The method of claim 1, wherein the step of determining the user advertising rating is based on one or more of the user's responses to a single advertiser.

13. The method of claim 1, wherein the step of determining the user advertising rating is based on one or more of the user's responses for a given location.

14. The method of claim 1, wherein the step of determining the user advertising rating is based on one or more of the user's responses for a given time range.

15. An advertising system for determining user advertising ratings, the advertising system comprising a data processing system for executing an effective response analysis engine (ERAE), wherein the advertising system is configured to:
send, for an advertiser, a set of one or more of the advertiser's advertisements to a user's wireless communication device;
for each of said one or more advertisements, associate location information with the advertisement, the location information indicating the geographic area in which the user's wireless communication device was located, or was assumed to be located, at the time the user's communication device received the advertisement;
in response to receiving information indicating that the user responded to at least one of the one or more advertisements, associate at least one of the one or more advertisements with information indicating that the user responded to the advertisement; and
determine a user advertising rating associated with the user and a geographic area based on i) a first value representing the number of advertisements that were transmitted to the user and associated with location information indicating the geographic area and ii) a second value representing the number of advertisements that were transmitted to the user and associated with the geographic area and also associated with information indicating that the user responded to the advertisement.

16. The system of claim 15, wherein the information indicating that the user responded to at least one of the one or more advertisements includes purchase information indicating that the user purchased a product from the advertiser.

17. The system of claim 15, wherein the information indicating that the user responded to at least one of the one or more advertisements includes purchase information indicating that the user used the wireless communication device to pay for the product.

18. The system of claim 15, wherein the information indicating that the user responded to at least one of the one or more advertisements includes purchase information indicating that the user used the wireless communication device to pay for the product via a contactless payment system.

19. A computer program product comprising a non-transitory computer readable medium storing a computer program, which, when executed by an advertising system, causes the advertising system to:
send, for an advertiser, a set of one or more of the advertiser's advertisements to a user's wireless communication device;
for each of said one or more advertisements, associate location information with the advertisement, the location information indicating the geographic area in which the user's wireless communication device was located, or was assumed to be located, at the time the user's communication device received the advertisement;
associate at least one of the one or more advertisements with information indicating that the user responded to the advertisement in response to receiving information indicating that the user responded to at least one of the one or more advertisements; and
determine a user advertising rating associated with the user and a geographic area based on i) a first value representing the number of advertisements that were transmitted to the user and associated with location information indicating the geographic area and ii) a second value representing the number of advertisements that were transmitted to the user and associated with the geographic area and also associated with information indicating that the user responded to the advertisement.
